(19) United States
(12) Patent Application Publication
(10) Pub. No.: US 2026/0265080 A1
(43) Pub. Date: Sep. 10, 2026

(54) LOW PT-LOADED MXENE-CARBON NANOTUBE AEROGEL FILM AND PREPARATION METHODS THEREOF

(71) Applicant: HEFEI INSTITUTES OF PHYSICAL SCIENCE, CHINESE ACADEMY OF SCIENCES, Hefei, Anhui (CN)

(72) Inventors: Bin CHEN, Hefei (CN); Xiang ZHANG, Hefei (CN); Qijun PAN, Hefei (CN); Rui WAN, Hefei (CN); Yuguang WANG, Hefei (CN); Xiaoxiao WU, Hefei (CN); Han CHEN, Hefei (CN)

(73) Assignee: HEFEI INSTITUTES OF PHYSICAL SCIENCE, CHINESE ACADEMY OF SCIENCES, Hefei, Anhui (CN)

(21) Appl. No.: 19/006,179

(22) Filed: Dec. 30, 2024

(30) Foreign Application Priority Data
Jan. 4, 2024 (CN) 202410010328.5

(51) Int. Cl. C01G 55/00; H01M 4/02; H01M 4/04; H01M 4/583

(52) U.S. Cl. CPC C01G 55/008; H01M 4/04; H01M 4/583; C01P 2004/13; C01P 2004/64; H01M 2004/023

(57) ABSTRACT

A low Pt-loaded MXene-carbon nanotube aerogel film and its preparation method are provided. The method includes adding an H₂PtCl₆ solution to a MXene nanosheet colloidal suspension to obtain a Pt@MXene nanosheet suspension, mixing the Pt@MXene nanosheet suspension with a carbon nanotube suspension to obtain a mixed suspension under ultrasonic treatment, and cooling a metal plate in liquid nitrogen in advance, placing the mixed suspension on a surface of the metal plate for rapid freezing, and freeze-drying to obtain a low Pt-loaded MXene-carbon nanotube aerogel film material with a vertical porous structure.

### CROSS-REFERENCE TO RELATED APPLICATIONS

This application claims priority to the Chinese Patent Application No. 202410010328.5, filed on Jan. 4, 2024, the contents of which are hereby incorporated by reference.

### TECHNICAL FIELD

The present disclosure relates to the technical field of hydrogen evolution electrodes, and in particular, to a low Pt-loaded MXene-carbon nanotube aerogel film and preparation method thereof.

### BACKGROUND

In order to address the energy crisis and the related environmental pollution, it is extremely urgent to develop clean energy. As one of the most promising clean energy sources, hydrogen shows great potential in replacing the dwindling fossil fuels. Compared with the traditional methods of hydrogen production by cracking fossil fuels, hydrogen production by electrolyzing water has the advantages of being clean, pollution-free, sustainable, and high purity. However, the reaction kinetics of the hydrogen evolution reaction (HER) is sluggish, and a relatively high overpotential needs to be overcome during the catalytic process. Therefore, there is an urgent need for highly active catalysts to promote the HER. Pt-based catalysts are recognized as the currently optimal HER catalysts due to their excellent hydrogen binding energy. Nevertheless, the high cost and scarcity of precious metals have seriously hindered their large-scale commercial applications. To solve this bottleneck, while maintaining high catalytic activity, reducing the particle size and the amount of Pt in the catalyst can significantly cut down the cost of the catalyst. In recent years, nanoclusters at the nanoscale or even sub-nanoscale and single-atom catalysts have become research hotspots because of their high mass activity. Meanwhile, the interaction between Pt species and the support jointly determines the catalytic activity and stability of the catalyst. Therefore, it is important for the improvement of catalytic performance to explore suitable catalyst supports.

HER catalysts are often synthesized in powder form and usually need to be mixed with polymer binders and then coated on conductive substrates (such as carbon cloth, glassy carbon, etc.) to prepare electrodes. However, these binders not only bury the active sites but also block mass transfer. Moreover, for the electrodes prepared by coating, the catalysts are prone to fall off from the electrode surface when operating at high current densities. At present, the maximum working current densities of the reported Pt-loaded MXene are mostly lower than 100 mA cm⁻², which is far from sufficient to meet the application requirements of industrial hydrogen production by electrolyzing water where the current density usually exceeds 500 mA cm⁻² or even 1000 mA cm⁻². On the other hand, the efficiency of HER is jointly determined by mass transfer and reaction kinetics. Especially at high current densities, the rapid supply of the electrolyte and the timely desorption of bubbles become the key factors in the reaction process. The H₂ bubbles that cannot be desorbed seriously clog the solid-liquid interface, and the local stress exerted by the bubbles further causes the catalysts to peel off from the electrode surface, thus degrading the overall performance of the electrodes. In the practical application of hydrogen production by electrolyzing water, electrocatalysts often need to drive amperage-level current densities at relatively low overpotentials.

Therefore, it is crucial for the practical application of MXene-based catalysts to construct low-Pt self-supporting electrodes capable of coping with industrial-level current density reactions.

### SUMMARY

One or more embodiments of the present disclosure provide a preparing method for a low Pt-loaded MXene-carbon nanotube aerogel film, comprising: S1, adding LiF to a HCl solution to prepare a composite etching solution, wherein a concentration of the HCl solution is within a range of 5.0-7.0 M, and an addition amount of the LiF in the HCl solution is within a range of 0.06-0.1 g/mL; slowly adding Ti₃AlC₂ powder to the composite etching solution, and mixing and stirring to obtain a colloidal solution, washing the colloidal solution with deionized water to separate a solid and drying the solid to obtain MXene nanosheets, and dispersing the MXene nanosheets in deionized water at a dispersion concentration of 60-100 mg/mL to obtain an MXene colloidal suspension; S2, slowly adding a H₂PtCl₆ solution to the MXene colloidal suspension to obtain a suspension, denoted as Pt@MXene nanosheet suspension, wherein Pt is loaded on the MXene nanosheets to obtain Pt-loaded MXene nanosheets, a concentration of the H₂PtCl₆ solution is within a range of 10-30 mg/mL, and a mass ratio of H₂PtCl₆ in the H₂PtCl₆ solution to the MXene nanosheets in the MXene colloidal suspension is within a range of (0.5-3): 100; S3, preparing a carbon nanotube (CNT) suspension, mixing the Pt@MXene nanosheet suspension with the carbon nanotube suspension to obtain a mixed suspension under ultrasonic treatment; wherein a concentration of the CNT suspension is within a range of 10-30 mg/mL, and a volume ratio of the Pt@MXene nanosheet suspension to the carbon nanotube suspension is 1:7; and S 4, cooling a metal plate in liquid nitrogen in advance, placing the mixed suspension on a surface of the metal plate for rapid freezing, and freeze-drying to obtain an aerogel film with a thickness of 0.4-1 mm, wherein the Pt-loaded MXene nanosheets and carbon nanotubes in the aerogel film are interlaced and overlapped to form vertical pores, which is the low Pt-loaded MXene-carbon nanotube aerogel film, and the low Pt-loaded MXene-carbon nanotube aerogel film is used as a self-supporting integrated industrial electrolytic water hydrogen production electrode.

In some embodiments, in step S1, the concentration of the HCl solution is within a range of 5.0-7.0 M, and the addition amount of the LiF in the HCl solution is within a range of 0.06-0.1 g/mL.

In some embodiments, in step S1, a mass ratio of the Ti₃AlC₂ powder to the LiF in the composite etching solution is within a range of (0.5-1):1.

In some embodiments, in step S4, a temperature of the freeze-drying is within a range of (−35° C.)-(−75°C.), and a time of the freeze-drying is within a range of 5-18 h.

One or more embodiments of the present disclosure provide a low Pt-loaded MXene-carbon nanotube aerogel film, which is prepared according to the above preparing method.

### BRIEF DESCRIPTION OF THE DRAWINGS

The present disclosure will be further illustrated by way of exemplary embodiments, which will be described in detail through the accompanying drawings, wherein:

FIG. 1 is a schematic diagram illustrating the process for preparing a Pt@MC-AF electrode according to some embodiments of the present disclosure;

FIG. 2 is an electron microscope image of a Pt@MC-AF electrode according to some embodiments of the present disclosure;

FIG. 3 is a top-view scanning electron microscopy (SEM) image and cross-sectional SEM image of a Pt@MC-RF electrode and a Pt@MC-Film electrode according to some embodiments of the present disclosure;

FIG. 4(a) is an X-Ray Diffraction (XRD) diagram of a Pt@MC-AF electrode, a Pt@MC-RF electrode, and a Pt@MC-Film electrode prepared according to some embodiments of the present disclosure; FIG. 4(b) is a schematic diagram of X-ray scattering in the horizontal and vertical directions of the Pt@MC-RF electrode according to some embodiments of the present disclosure; FIG. 4(c) is an enlarged XRD diagram of the Pt@MC-AF electrode, a Pt@M-AF electrode, and an M-AF electrode according to some embodiments of the present disclosure; FIG. 4(d) is a Pt 4f X-ray photoelectron spectroscopy (XPS) spectrum of the Pt@MC-AF electrode according to some embodiments of the present disclosure; FIG. 4(e) is a Ti 2p XPS spectrum of the Pt@MC-AF electrode and the MC-AF electrode according to some embodiments of the present disclosure;

FIG. 5(a) is an HER Linear Sweep Voltammetry (LSV) curve of a MC-AF electrode, Pt@MC-Film electrode, a Pt@MC-Powder electrode, a Pt@MC-RF electrode, a Pt@MC-AF electrode, and a commercial Pt/C powder catalyst according to some embodiments of the present disclosure; FIG. 5(b) is a mass activity diagram of the Pt@MC-AF electrode and the commercial Pt/C powder catalyst according to some embodiments of the present disclosure; FIG. 5(c) is a Tafel plot corresponding to polarization curves of the Pt@MC-Powder electrode, the Pt@MC-Film electrode, the Pt@MC-RF electrode, the Pt@MC-AF electrode, and the commercial Pt/C powder catalyst according to some embodiments of the present disclosure; FIG. 5(d) is a double-layer capacitance diagram of the Pt@MC-AF electrode, the Pt@MC-RF electrode, and the Pt@MC-Film electrode obtained at different scanning rates according to some embodiments of the present disclosure; and

FIG. 6(a) is a schematic diagram illustrating a contact angle of water droplet on the surface of a Pt@MC-Film electrode according to some embodiments of the present disclosure; FIG. 6(b) is a schematic diagram illustrating a contact angle of water droplet on a Pt@MC-AF electrode according to some embodiments of the present disclosure, respectively; FIG. 6(c) is a schematic diagram illustrating the bubble contact angle of the Pt@MC-AF electrode underwater according to some embodiments of the present disclosure; FIG. 6(d) is a stability test diagram of the Pt@MC-AF electrode at different currents according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor.

One or more embodiments of the present disclosure provide a preparing method for a low Pt-loaded MXene-carbon nanotube aerogel film, comprising: S1, adding LiF to a HCl solution to prepare a composite etching solution, wherein a concentration of the HCl solution is within a range of 5.0-7.0 M, and an addition amount of the LiF in the HCl solution is within a range of 0.06-0.1 g/mL; slowly adding Ti₃AlC₂ powder to the composite etching solution, and mixing and stirring to obtain a colloidal solution, washing the colloidal solution with deionized water to separate a solid and drying the solid to obtain MXene nanosheets, and dispersing the MXene nanosheets in deionized water at a dispersion concentration of 60-100 mg/mL to obtain an MXene colloidal suspension.

In some embodiments, in step S1, the concentration of the HCl solution is within a range of 5.0-7.0 M, and the addition amount of the LiF in the HCl solution is within a range of 0.06-0.1 g/mL.

In some embodiments, in step S1, the concentration of the HCl solution is 6.0 M, and the addition amount of the LiF in the HCl solution is 0.08 g/mL.

In some embodiments, in step S1, a mass ratio of the Ti₃AlC₂ powder to the LiF in the composite etching solution is within a range of (0.5-1):1.

In some embodiments, in step S1, a mass ratio of the Ti₃AlC₂ powder to the LiF in the composite etching solution is 0.625:1.

In some embodiments, in step S1, MXene nanosheets are dispersed in deionized water at a dispersion concentration of 60-100 mg/mL, to obtain a MXene colloidal suspension.

MXene nanosheets are a new type of two-dimensional nanomaterial belonging to the family of transition metal carbides, nitrides, or carbonitrides. The embodiments of the present disclosure employ selective etching of “A” element from the MAX phase to prepare layered MXene nanosheets, where the “M” represents a pre-transition metal, the “A” represents a main group element from group IIIA or IVA, and the “X” represents C and/or N element. During the etching process, the “A” atom between the MAX layers is replaced by terminal functional groups such as fluorine and hydroxyl, causing the etched MXene to exhibit metallic electronic conductivity, excellent hydrophilic surface, and abundant surface functional groups. Additionally, due to the oxidation number of the “M” in MXene being much lower than that of the corresponding oxides, these groups on the surface of MXene can also act as reducing agents for certain metal cations.

S2, slowly adding a H₂PtCl₆ solution to the MXene colloidal suspension to obtain a suspension, denoted as Pt@MXene nanosheet suspension, and Pt being loaded on MXene nanosheets in the suspension.

In some embodiments, in step S1, MXene nanosheets are dispersed in deionized water at a dispersion concentration of 80 mg/mL, to obtain a MXene colloidal suspension.

In some embodiments, in step S2, a concentration of the H₂PtCl₆ solution is within a range of 10-30 mg/mL, and a mass ratio of H₂PtCl₆ in the H₂PtCl₆ solution to the MXene nanosheets in the MXene colloid suspension is within a range of (0.5-3):100.

In some embodiments, in step S2, a concentration of the H₂PtCl₆ solution is 20 mg/mL, and a mass ratio of H₂PtCl₆ in the H₂PtCl₆ solution to the MXene nanosheets in the MXene colloid suspension is 1.5:100.

S3. preparing a carbon nanotube (CNT) suspension, and mixing the Pt@MXene nanosheet suspension with the CNT suspension to obtain a mixed suspension under ultrasonic treatment.

In some embodiments, in step S3, a concentration of the CNT suspension is within a range of 10-30 mg/mL, and a volume ratio of the Pt@MXene nanosheet suspension to the carbon nanotube suspension is 1:7.

In some embodiments, in step S3, a concentration of the CNT suspension is 20 mg/mL, and a volume ratio of the Pt@MXene nanosheet suspension to the carbon nanotube suspension is 1:7.

S4, cooling a metal plate in liquid nitrogen in advance, placing the mixed suspension on a surface of the metal plate for rapid freezing, and freeze-drying to obtain an aerogel film, wherein the Pt-loaded MXene nanosheets and carbon nanotubes in the aerogel film are interlaced and overlapped to form vertical pores, which is the low Pt-loaded MXene-carbon nanotube aerogel film.

In some embodiments, in step S4, a temperature of the freeze-drying is within a range of (−35° C.)-(−75°C.), and a time of the freeze-drying is within a range of 5-18 h.

In some embodiments, in step S4, a temperature of the freeze-drying is −55° C., and a time of the freeze-drying is 7 h.

In some embodiments, a thickness of the aerogel film in step S4 is within a range of 0.4-1 mm.

In some embodiments, a thickness of the aerogel film in step S4 is 0.8 mm.

The embodiments of the present disclosure provide a preparing method for a low-Pt loaded MXene-carbon nanotube aerogel film, which has the advantages of low cost, simple process, and scalable preparation, offering a new approach for the rational design, preparation, and widespread application of efficient electrocatalytic hydrogen evolution electrodes under industrial current densities.

One or more embodiments of the present disclosure provide a low-Pt loaded MXene-carbon nanotube aerogel film, which is prepared according to the above-mentioned preparing method for low-Pt-loaded MXene-carbon nanotube aerogel film.

One or more embodiments of the present disclosure also provide an application of the above-mentioned Pt-loaded MXene-carbon nanotube aerogel film as a self-supporting integrated industrial water electrolysis hydrogen production electrode.

The electrode obtained from the low-Pt loaded MXene-carbon nanotube aerogel film provided by the embodiments of the present disclosure has advantages such as a large specific surface area, numerous active sites, excellent hydrophilicity, and efficient mass transfer rates, thereby exhibiting high electrocatalytic activity and excellent long-term stability under high current densities.

Embodiments of the present disclosure at least have the following beneficial effects.

(1) According to embodiments of the present disclosure, ultra-thin Ti₃C₂Tx nanosheets are obtained by etching utilizing LiF and HCl, and the ultra-thin Ti₃C₂Tx nanosheets are then dispersed in deionized water to form a MXene colloidal suspension. H₂PtCl₆ solution is slowly added to the MXene colloidal suspension to obtain a suspension, and Pt is loaded onto the MXene nanosheets in the suspension. The suspension is then mixed with a carbon nanotubes (CNTs) suspension to form a mixed suspension. The significant electron-donating ability of MXene spontaneously reduces the PtCl₆ ²⁻ ions, anchoring them uniformly and firmly onto the surface of the MXene nanosheets. By introducing CNTs as a binder, the adjacent MXene nanosheets are firmly connected, and the cross-linked MXene nanosheets and CNTs greatly enhance the overall mechanical strength of the electrode, which is beneficial for alleviating the damage to the electrode from localized stress of bubbles. At the same time, the combination of one-dimensional CNTs and two-dimensional MXene nanosheets provides a high-speed electronic transmission network for a three-dimensional integrated electrode. Subsequently, the mixed suspension is rapidly frozen on the surface of a metal plate that has been pre-cooled in liquid nitrogen, driven by the vertical temperature difference, MXene and CNTs are compressed by the growing ice crystals, forming a porous structure with vertically aligned pores. After freeze-drying, the aerogel film with interlaced and overlapped low Pt-loaded (adjustable to about 0.48%) of MXene nanosheets and carbon nanotubes (denoted as Pt@MC-AF) is obtained. This aerogel film can be used as a high-performance self-supporting electrode for HER (denoted as Pt@MC-AF electrode).

(2) The Pt@MC-AF electrode prepared in embodiment of the present disclosure has a highly exposed solid-liquid-gas interface, and the assembled three-dimensional interconnected nanostructure provides abundant active sites for catalytic reactions. Benefiting from this unique structure, the self-supporting Pt@MC-AF electrode exhibits good superhydrophilicity and underwater superhydrophobicity, while the vertically aligned pore structure significantly promotes the desorption of gas products and the diffusion rate of the electrolyte. In addition, the Pt content of the final electrode can be adjusted by controlling the addition amount of H₂PtCl₆, and the thickness of the integrated electrode can be adjusted by adjusting the volume of the rapidly frozen mixed suspension.

(3) The Pt@MC-AF electrode with three-dimensional interconnected nanostructure obtained in the embodiment of the present disclosure has excellent HER performance, with a mass activity far superior to commercial precious metal Pt/C, providing new methods for the preparation of subsequent catalyst electrodes. Based on these advantages, the Pt@MC-AF electrode presents a high hydrogen evolution performance. In a 0.5 M H₂SO₄ electrolyte, a current density of 1000 mA cm⁻² can be driven with only 249 mV overpotential, and it has a smaller Tafel slope and excellent long-term stability. The simple electrode preparation process avoids the use of additional reducing agents and complex post-treatment, laying the foundation for the large-scale preparation of high-current electrolytic water hydrogen evolution electrodes.

(4) The low Pt-loaded MXene-carbon nanotube aerogel film and its preparation method provided in the embodiments of the present disclosure have the advantages of low cost, simple process, and scale preparation, which is expected to be extended to other electrochemical application fields such as supercapacitors, zinc-air batteries, and fuel cells.

The experimental techniques in the following examples, unless otherwise specified, are conventional techniques. The test materials used in the following examples, unless otherwise specified, are obtained from standard biochemical reagent companies. Quantitative assays in the following examples are performed with three replicate experiments, and the results are averaged.

### EXAMPLES

### Example 1

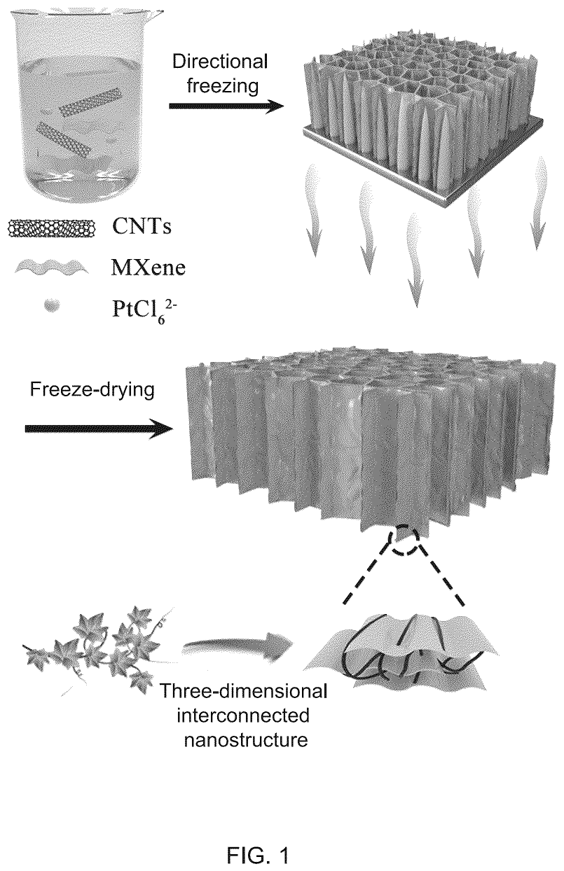

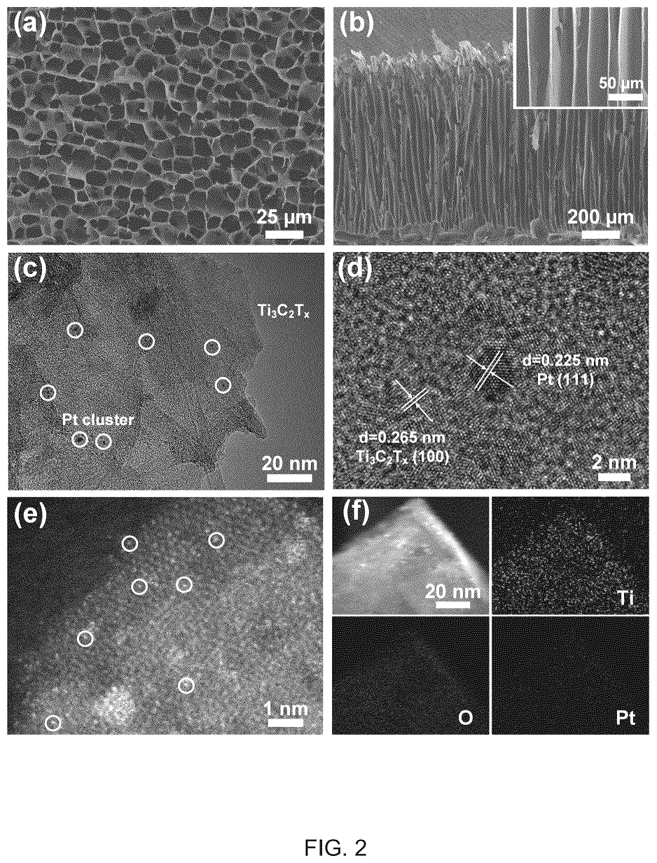

The example provided a preparing method for a low Pt-loaded MXene-carbon nanotube aerogel film (denoted as Pt@MC-AF), with the preparation process shown in FIG. 1, specifically including:
step 1): 3.2 g of LiF was added to 40 mL of 6.0 M HCl solution to prepare a composite etching solution;
step 2): 2 g of Ti₃AlC₂ powder was slowly added to the composite etching solution, with the mass ratio of Ti₃AlC₂ powder to LiF of 0.625:1, mixed and stirred to obtain a colloidal solution, the colloidal solution was washed with deionized water to separate the solid and the solid was dried to obtain MXene nanosheets, the MXene nanosheets are dispersed in deionized water at a dispersion concentration of 80 mg/mL to obtain an MXene colloidal suspension;
step 3): 1 mL of the MXene colloidal suspension was taken, 60 μl of 20 mg/mL H₂PtCl₆ solution was slowly added into the MXene colloidal suspension, a mass ratio of H₂PtCl₆ in the H₂PtCl₆ solution to the MXene nanosheets in the MXene colloidal suspension was 1.5:100, denoted as Pt@MXene nanosheet suspension;
step 4): 20 mg/mL carbon nanotube (CNT) suspension was prepared, and the Pt@MXene nanosheet suspension was mixed with the carbon nanotube suspension in a volume ratio of 1:7 under ultrasonic treatment to obtain a mixed suspension;
step 5): a copper plate was cooled in liquid nitrogen in advance, an appropriate amount of Pt@MXene nanosheet suspension was taken and placed on the surface of the copper plate for rapid freezing, then the Pt@MXene nanosheet suspension was freeze-dried at −55° C. for 7 h to obtain a vertically porous and low-Pt-loaded MXene-carbon nanotube aerogel film (denoted as Pt@MC-AF), with a thickness of 0.8 mm. After being tested by inductively coupled plasma optical emission spectrometry, the Pt loading amount in the film accounted for 0.48% of the total mass of the film.

The Pt@MC-AF used as a HER electrode is denoted as the Pt@MC-AF electrode.

### Example 2

The example provided a preparing method for a Pt@MXene-CNTs randomly porous aerogel film (denoted as Pt@MC-RF). The specific steps referred to Example 1, with the difference being that the specific operation of step 5) was as follows:

An appropriate amount of the mixed suspension was taken and placed i a refrigerator at −30° C. for conventional freezing for 2 h, then dried at −55° C. for 7 h to obtain a Pt@MXene-CNTs randomly porous aerogel film (denoted as Pt@MC-RF), with a thickness of 0.8 mm. After being tested by inductively coupled plasma optical emission spectrometry, the Pt loading amount in the film accounted for 0.48% of the total mass of the film.

The Pt@MC-RF used as a HER electrode is denoted as the Pt@MC-RF electrode.

### Example 3

The example provided a preparing method for a Pt@MXene-CNTs film (denoted as Pt@MC-Film). The specific steps referred to Example 1, with the difference being that the specific operation of step 5) was as follows:

An appropriate amount of the mixed suspension was taken and a Pt@MXene-CNTs film was obtained by vacuum filtration of the mixed suspension, with a thickness of 0.8 mm. After being tested by inductively coupled plasma optical emission spectrometry, the Pt loading amount in the film accounted for 0.48% of the total mass of the film.

The Pt@MC-Film used as a HER electrode is denoted as the Pt@MC-Film electrode.

### Example 4

The example provided a preparing method for a Pt@MXene vertically porous aerogel film (denoted as Pt@M-AF), referring to steps 1)-3) of Example 1, a Pt@MXene nanosheet suspension was prepared. A copper plate was cooled in liquid nitrogen in advance, an appropriate amount of Pt@MXene nanosheet suspension was taken and placed on the surface of the copper plate for rapid freezing, then the frozen Pt@MXene nanosheet suspension was freeze-dried at −55° C. for 7 h to obtain a Pt@MXene vertically porous aerogel film (denoted as Pt@M-AF), with a thickness of 0.8 mm.

The Pt@M-AF used as a HER electrode is denoted as the Pt@M-AF electrode.

### Example 5

The example provided a preparing method for a MXene vertically porous aerogel film (denoted as M-AF), referring to steps 1) and 2) of Example 1, a MXene colloidal suspension was obtained. A copper plate was cooled in liquid nitrogen in advance, an appropriate amount of MXene colloidal suspension was taken and placed on the surface of the copper plate for rapid freezing, then the frozen MXene colloidal suspension was freeze-fried at −55° C. for 7 h to obtain a MXene vertically porous aerogel film (denoted as M-AF), with a thickness of 0.8 mm.

The M-AF used as a HER electrode is denoted as the M-AF electrode.

### Example 6

The example provided a preparing method for a MXene-CNTs vertically porous aerogel film (denoted as MC-AF). The specific steps referred to Example 1, with the difference being that the operation of step 3) was not carried out, the MXene colloidal suspension obtained in steps 1) and 2) was directly mixed with the carbon nanotube suspension to obtain a mixed suspension, then rapid freezing and freeze-drying were performed on the mixed suspension to obtain a MXene-CNTs vertically porous aerogel film (denoted as MC-AF), with a thickness of 0.8 mm.

The MC-AF used as a HER electrode is denoted as the MC-AF electrode.

### Example 7

The example provided a preparing method for a Pt@MXene-CNTs powder film (denoted as Pt@MC-Powder). Referring to Example 1, Pt@MC-AF was prepared, and the preparing method further included as following:

Under ultrasonic condition, 30 mg of Pt@MC-AF was taken and mixed with 50 μL Nafion solution, 1.0 mL ethanol, and 0.45 mL deionized water to obtain a mixed slurry, the mixed slurry was then drop-coated onto a glassy carbon surface and dried to form a film, which is the Pt@MXene-CNTs powder film (denoted as Pt@MC-Powder), with a thickness of 0.8 mm. After being tested by inductively coupled plasma optical emission spectrometry, the Pt loading amount in the film accounted for 0.48% of the total mass of the film.

The Pt@MC-Powder used as a HER electrode is denoted as the Pt@MC-Powder electrode.

### Performance Testing

### (1) Morphology and Structural Characterization of Electrodes

The Pt@MC-AF electrode prepared in Example 1 was characterized using techniques such as transmission electron microscopy (TEM), X-ray diffraction (XRD), X-ray photoelectron spectroscopy (XPS), field emission scanning electron microscopy (FE-SEM), and energy-dispersive X-ray spectroscopy (EDS). The results are shown in FIG. 2, where (a) and (b) are the top-view SEM image and cross-sectional SEM image of the electrode, respectively, (c), (d), (e), and (f) are the TEM image, high-resolution transmission electron microscopy (HRTEM) image, atomic-resolution high-angle annular dark-field scanning transmission electron microscopy (HAADF-STEM) image, and energy-dispersive X-ray spectroscopy (EDS) spectrum of the electrode, respectively. As shown in the top-view SEM image of (a) in FIG. 2, the Pt@MC-AF electrode consists of many interconnected and highly oriented porous structures. As shown in the cross-sectional SEM image of (b) in FIG. 2, the Pt@MC-AF electrode exhibits a large area of uniform long-range vertical alignment. Additionally, the insert image (at upper right corner of (b)) of (b) in FIG. 2 indicates that the average width of the vertical channels is 20 μm, which facilitates the release of bubbles during the reaction process. Subsequently, the Pt@MC-AF electrode was further characterized using TEM. As shown in the TEM image of (c) in FIG. 2, ultra-small Pt clusters (less than 2 nm) are loaded on the surface of MXene nanosheets. At the same time, 1D CNTs and 2D Pt@MXene are closely interwoven together, like an ivy plant, with CNTs firmly grasping and connecting adjacent nanosheets to form a continuous structure. The HRTEM image of (d) in FIG. 2 shows a lattice spacing of 0.265 nm corresponding to the plane (100) of Ti₃C₂Tx and a lattice spacing of 0.225 nm corresponding to the plane (111) of Pt. The atomic-resolution spherical aberration-corrected scanning transmission electron microscopy image of (e) in FIG. 2 indicates that, in addition to Pt clusters of 2 nm, a large number of single-dispersed Pt single-atom sites are observed on the MXene matrix. Furthermore, the EDS spectrum of (f) in FIG. 2 also shows that Pt species are uniformly dispersed on the surface of MXene nanosheets. The above results indicate that MXene nanosheets have a strong ability to donate electrons and can spontaneously reduce PtCl₆²⁻ ions into Pt clusters and single atoms in situ without reducing agents at room temperature and fix them on the surface of MXene nanosheets.

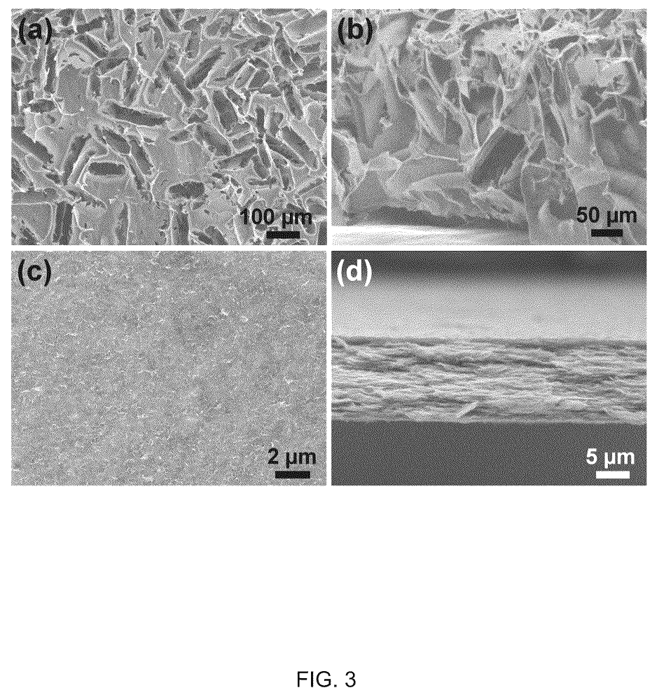

For comparison, Pt@MC-RF electrode and Pt@MC-Film electrode were prepared by subjecting the same mixed suspension with the same Pt loading to conventional freezing in a refrigerator (Example 2) and vacuum-assisted filtration (Example 3), respectively. The top-view and cross-sectional SEM images of the Pt@MC-RF electrode are shown in (a) and (b) of FIG. 3, respectively, indicating that the Pt@MC-RF electrode prepared by non-oriented freezing has randomly distributed and largely aggregated porous structures, with uneven pore sizes and discontinuous pores that would block active sites, which is detrimental to the exclusion of bubbles during the HER process. The top-view and cross-sectional SEM images of the Pt@MC-Film electrode are shown in (c) and (d) of FIG. 3, respectively, indicating that in Pt@MC-Film, carbon nanotubes and Pt-loaded MXene nanosheets are closely stacked into a film structure.

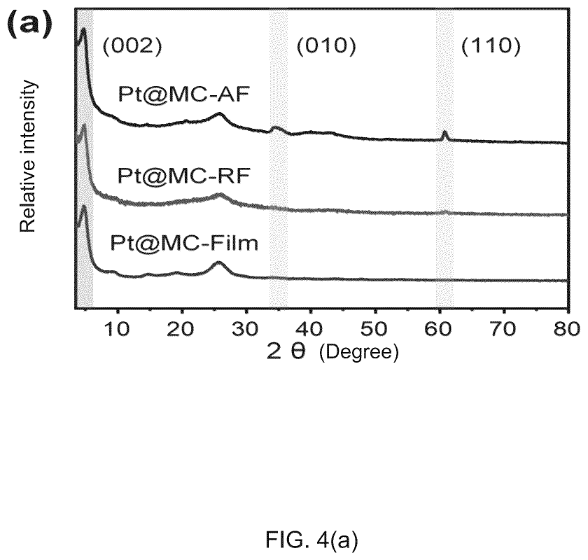

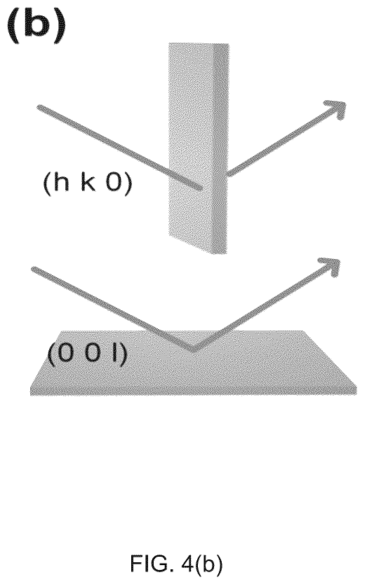

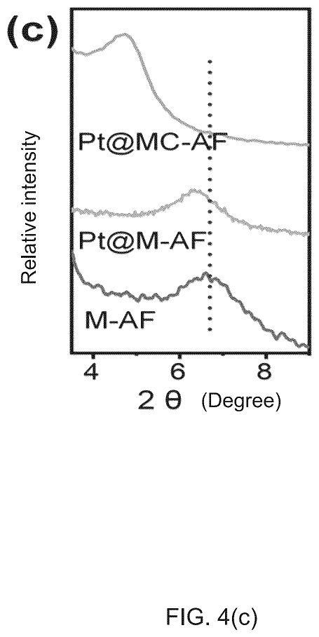

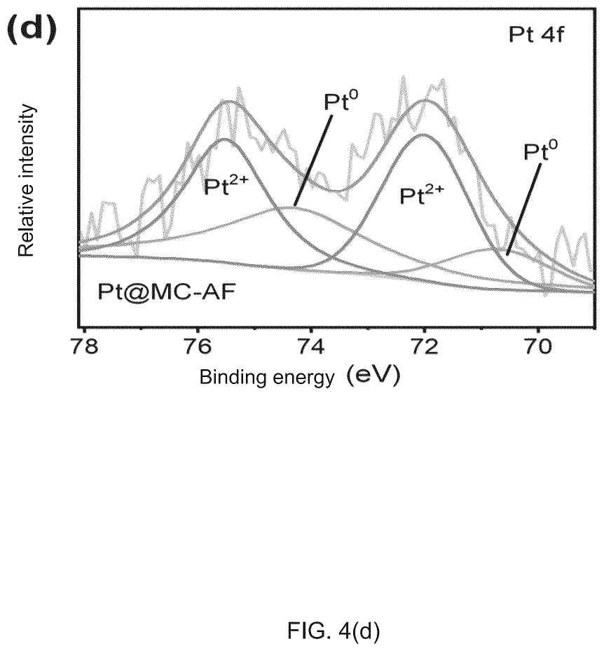

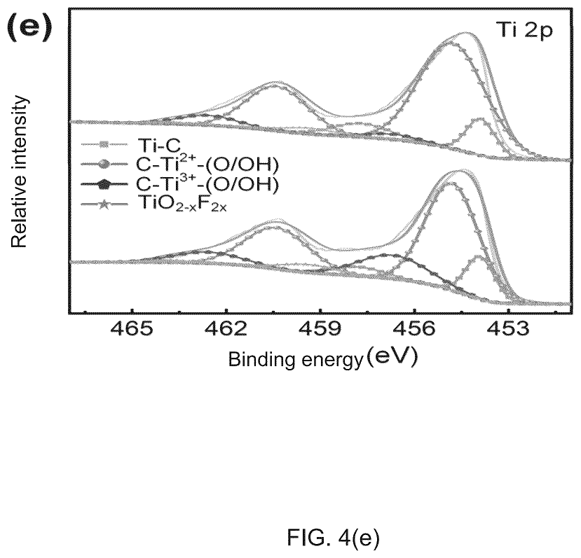

Subsequently, the structure and chemical composition of the samples prepared in Examples 1-3 were further studied using XRD. As shown in FIG. 4(a), the XRD diagram of the Pt@MC-AF electrode, Pt@MC-RF electrode, and Pt@MC-Film electrode prepared in Examples 1-3 indicates that the diffraction peak at 2θ=25.8° corresponds to the graphite plane (002) in CNTs. For the Pt@MC-Film electrode and Pt@MC-RF electrode, only one high-intensity diffraction peak of plane (002) of MXene is shown, while for the Pt@MC-AF electrode, two major diffraction peaks belonging to the plane family (110) and (010) are also detected, which further proves that the MXene in the constructed Pt@MC-AF electrode has a high degree of vertical orientation.

FIG. 4(b) is a schematic diagram of X-ray scattering in the horizontal and vertical directions of Pt@MC-RF electrode prepared in Example 2; the presence of reflection plane (hk0) indicates that MXene nanosheets form vertical structures perpendicular to the plane orientation during the directional freezing process. Due to the absence of ice crystals growing vertically, the diffraction peak intensity of plane (hk0) of the Pt@MC-RF prepared by conventional freezing in a refrigerator in Example 2 is very weak, which further proves that directional freezing plays an important role in constructing vertical porous structures. At the same time, no Pt diffraction peak is observed in all samples, further indicating that the Pt species prepared using MXene spontaneous reduction are small in size.

In addition, FIG. 4(c) is an enlarged XRD diagram of the Pt@MC-AF electrode prepared in Example 1, the Pt@M-AF electrode prepared in Example 4, and the M-AF electrode prepared in Example 5. FIG. 4(c) indicates that after adding H₂PtCl₆ and CNTs respectively, the diffraction peak of plane (002) of MXene gradually shifts to the left, indicating that the addition of CNTs and the growth of Pt clusters/single atoms gradually increase the interlayer spacing of MXene nanosheets, which helps the Pt@MC-AF electrode to expose more active sites during the HER reaction. The surface chemical state of the Pt@MC-AF electrode was further characterized using X-ray photoelectron spectroscopy (XPS).

FIG. 4(d) is the Pt 4f XPS spectrum of the Pt@MC-AF electrode prepared in Example 1, which may be fitted into two sets of double peaks at 70.72/74.3 eV and 71.89/75.6 eV, corresponding to zero-valent Pt and Pt²⁺ species, respectively. The presence of partially positively charged Pt species indicates an interaction between Pt and MXene, which helps to improve the catalyst activity in the HER process. By comparing the XPS results of the Ti 2p spectrum, it is clearly confirmed that the surface valence state conversion before and after the redox reaction between MXene with PtCl₆²⁻ ions.

FIG. 4(e) is the Ti 2p XPS spectrum of the Pt@MC-AF electrode prepared in Example 1 and the MC-AF electrode prepared in Example 6. In Ti 2p (FIG. 4(e)), four 2p1/2 and 2p3/2 double peaks are observed, corresponding to Ti-C, C-Ti²⁺-(O/OH), C-Ti³⁺-(O/OH), and TiO₂₋ₓF₂ₓ. Compared with the MC-AF electrode of Example 6, the intensity of the C-Ti³⁺-(O/OH) peak of the Pt@MC-AF electrode of Example 1 is significantly increased, which further indicates that during the spontaneous reaction, highly reducible Ti species reduce PtCl₆²⁻ to Pt and Pt²⁺.

(2) Hydrogen evolution performance testing and analysis, contact angle (CA) testing, electrochemical impedance spectroscopy (EIS), electrochemically active surface area (ECSA) (or cyclic voltammetry, CV) testing.

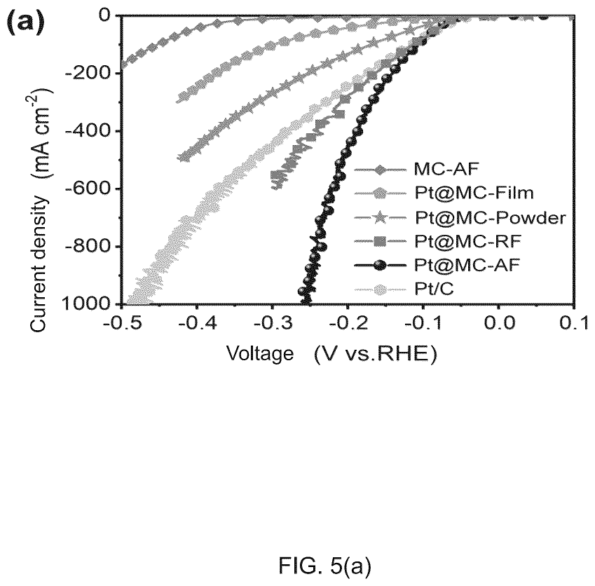

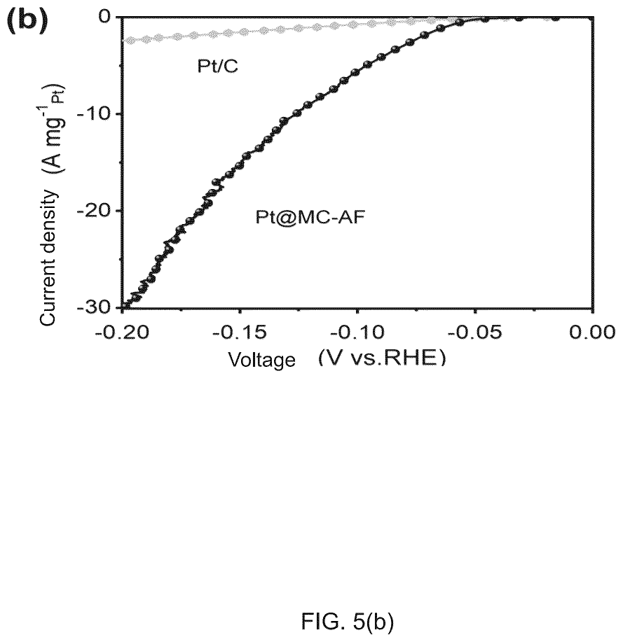

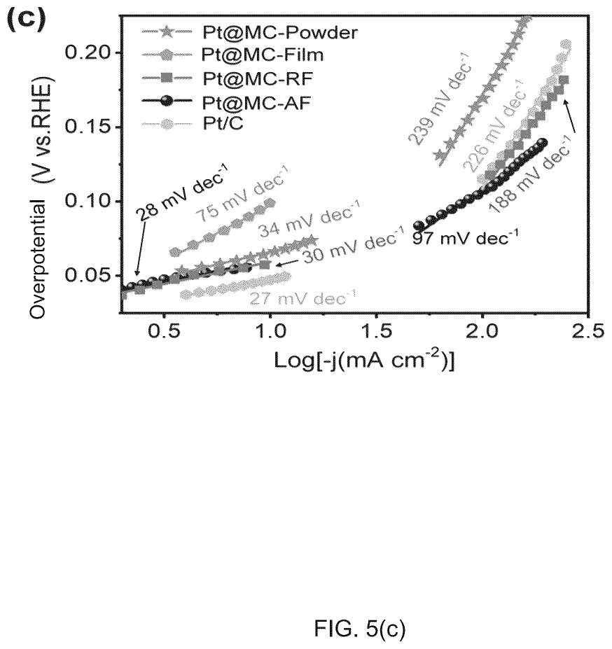

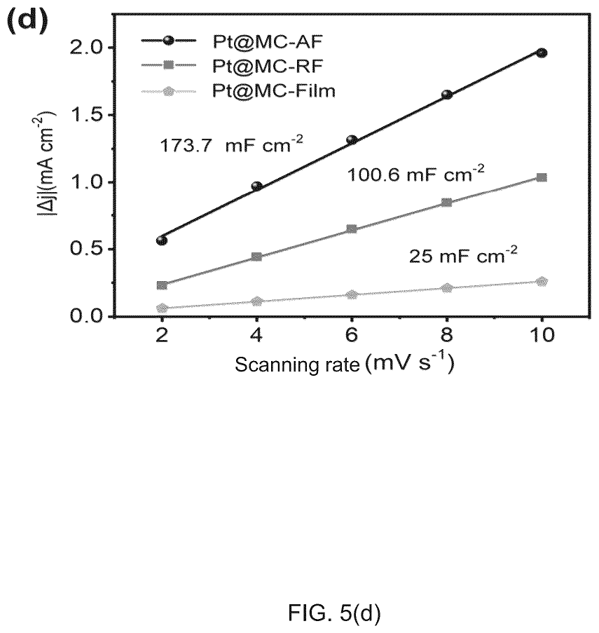

Electrochemical tests were performed in a standard three-electrode system in 0.5 M H₂SO₄. An Ag/AgCl electrode was used as the reference electrode, a graphite rod was used as the counter electrode, and all measured potentials were corrected to the reversible hydrogen electrode (RHE) potential using the Nernst equation. The HER activity of the MC-AF electrode prepared in Example 6, the Pt@MC-Film electrode prepared in Example 3, the Pt@MC-Powder electrode prepared in Example 7, the Pt@MC-RF electrode prepared in Example 2, the Pt@MC-AF electrode prepared in Example 1, and the commercial Pt/C powder catalyst (20 wt %, CAS: 7440-06-4) purchased from the Mecrinn Reagent Platform was investigated. At the same time, linear sweep voltammetry (LSV) measurements were performed at a rate of 2 mV s⁻¹, and the linear sweep voltammetry (LSV) curves are shown in FIG. 5(a).

As can be seen from FIG. 5(a), compared with the electrode loaded with Pt, the HER performance of the MC-AF electrode without modified Pt in Example 6 is negligible, indicating that the Pt species anchored on the MXene play a key role in the HER process. For the four different structures of electrodes prepared with the same Pt loading amount of MXene-CNTs suspension, the Pt@MC-Film electrode and the Pt@MC-Powder electrode exhibit relatively poor catalytic activity due to their low specific surface area; in contrast, the ordered vertical porous Pt@MC-AF electrode and the random porous Pt@MC-RF exhibit higher catalytic activity. Notably, the Pt@MC-AF electrode and the Pt@MC-RF electrode show similar polarization curves at low current densities, but at high current densities, the ordered vertical porous Pt@MC-AF electrode exhibits superior HER performance, which further demonstrates the key role of the three-dimensional ordered vertical channels. Studies have shown that under high current density conditions, the diffusion of the electrolyte and the desorption of gases play a crucial role in the HER reaction rate of the electrode. The Pt@MC-AF electrode has numerous ordered vertical arranged pore structures, which are beneficial for mass transfer and gas desorption. In particular, the catalytic performance of the Pt@MC-AF electrode prepared in the embodiment is close to or even superior to that of commercial Pt/C powder catalysts. Specifically, at low current densities, the activity of the Pt@MC-AF electrode is similar to that of commercial Pt/C powder catalyst. At high current densities, the catalytic activity of the Pt@MC-AF electrode is far superior to that of the commercial Pt/C powder catalyst. For example, at current densities of 100 and 500 mA cm⁻², the overpotential required for the Pt@MC-AF electrode is only 107 and 208 mV, respectively, while the overpotential for the commercial Pt/C powder catalysts is 115 and 325 mV, respectively.

To objectively compare the catalytic activity, the mass activity of the catalyst was studied by normalizing the current density and Pt loading amount of the Pt@MC-AF electrode and the Pt/C powder catalyst. As shown in FIG. 5(b), the mass activity of the Pt@MC-AF electrode is much higher than that of the commercial Pt/C powder catalyst. Specifically, the Pt@MC-AF electrode exhibits a mass activity of 5.59 A mg Pt⁻¹ at an overpotential of 100 mV, which is approximately 8 times that of the commercial Pt/C powder catalyst.

To further explore the HER kinetics of the catalyst, FIG. 5(c) is a Tafel plot corresponding to polarization curves of the Pt@MC-Powder electrode in Example 7, the Pt@MC-Film electrode in Example 3, the Pt@MC-RF electrode in Example 2, the Pt@MC-AF electrode in Example 1, and the commercial Pt/C powder catalyst. The commercial Pt/C powder catalyst exhibits a lower Tafel slope in the low current density region. However, at high current densities, the Pt@MC-AF electrode in Example 1 exhibits the smallest Tafel slope (97 mV dec-1), indicating that it has a fast electrocatalytic rate and excellent HER reaction kinetics.

In addition, the electrochemical active surface area (ECSA) evaluated by the double-layer capacitance (Cdl) is also considered a key factor for HER performance. As shown in FIG. 5(d), the double-layer capacitance for the Pt@MC-AF electrode in Example 1, the Pt@MC-RF electrode in Example 2, and the Pt@MC-Film electrode in Example 3 at different scanning rates is obtained. The Pt@MC-AF electrode in Example 1 exhibits a Cdl of 173.7 mF cm⁻², which is significantly higher than that of the Pt@MC-Film electrode in Example 3 (25 mF cm⁻²) and the Pt@MC-RF electrode in Example 2 (100.6 mF cm⁻²), indicating that the ordered vertical porous Pt@MC-AF electrode exposes more active sites. The higher ECSA further proves the important role of the oriented porous and 3D interconnected nanostructures, which greatly improves the accessibility of active sites, thereby improving the surface utilization efficiency of the porous structure.

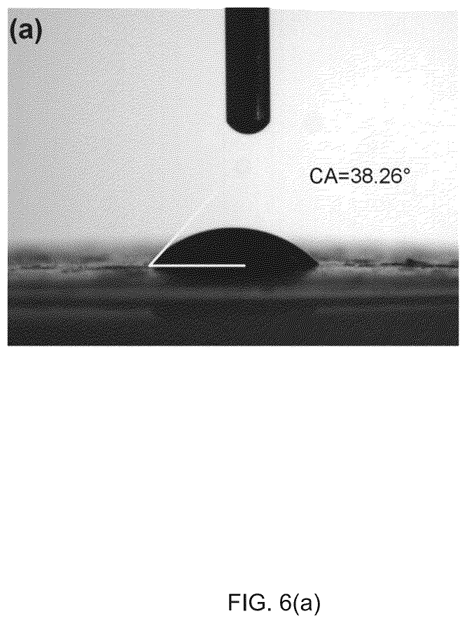

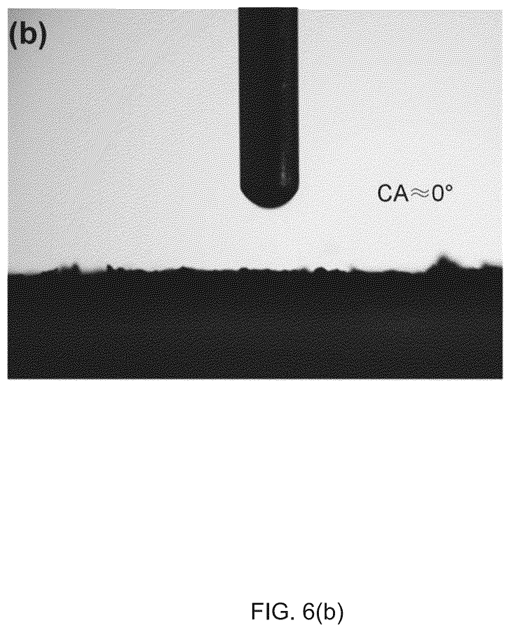

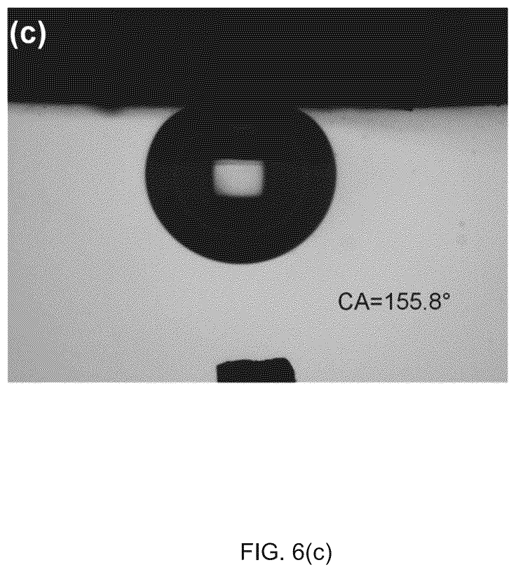

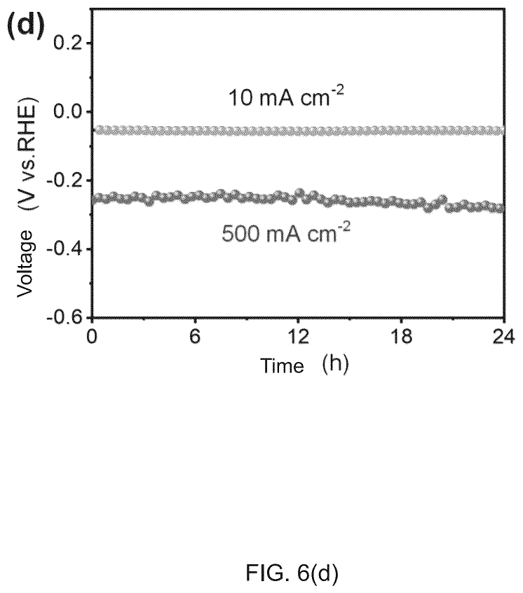

Furthermore, the hydrophilicity of the electrode surface directly affects the release of bubbles and the interfacial reaction of the electrolyte, playing an important role in the HER process. FIG. 6(a) is a schematic diagram illustrating a contact angle of water droplet on the surface of the Pt@MC-Film electrode in Example 3, and FIG. 6(b) is a schematic diagram illustrating a contact angle of water droplet on the surface of the Pt@MC-AF electrode in Example 1. The water droplet contact angle (CA) test (as shown in FIG. 6(a)) shows that the contact angle of the Pt@MC-Film electrode surface is 38.26, showing a certain degree of hydrophobicity. By comparison, the water droplet immediately disperses upon contact with the surface of the Pt@MC-AF electrode, with a static contact angle CA approximately equal to 0, as shown in FIG. 6(b), indicating that the Pt@MC-AF electrode exhibits superhydrophilic characteristics. The superhydrophilic surface and the capillary force caused by the oriented pores can guide the electrolyte to penetrate into the depth of the Pt@MC-AF electrode, forming a highly exposed solid-liquid interface.

FIG. 6(c) a schematic diagram illustrating the bubble contact angle of the Pt@MC-AF electrode in Example 1 underwater. As shown in FIG. 6(c), under the underwater environment, a high bubble contact angle (155.8°) is observed on the surface of the Pt@MC-AF electrode, indicating that bubbles can be easily separated. Therefore, the vertical porous structure of the Pt@MC-AF electrode surface can further improve the mass transfer efficiency by promoting gas transport and the interfacial reaction of the electrolyte.

FIG. 6(d) is the stability test diagram of the Pt@MC-AF electrode in Example 1 at different currents. As shown in FIG. 6(d), the stability of the sample was evaluated by constant current testing at a constant current density of 10 and 500 mA cm⁻². After continuous testing for 24 h, the Pt@MC-AF electrode only shows a slight increase in stability, indicating that the Pt@MC-AF electrode still has good long-term durability at high current densities. This can be attributed to the addition of CNTs, which significantly improves the mechanical strength of the integrated electrode as a whole. At the same time, the oriented porous and three-dimensional interconnected nanostructures, as well as the superhydrophilic and underwater gas-repellent characteristics of the surface, significantly reduce the damage to the electrode structure caused by the accumulation of bubbles during the reaction process. These unique advantages further indicate that the Pt@MC-AF electrode with high specific surface area, superhydrophilicity, and high activity is expected to replace commercial precious metal catalysts for industrial large-current water electrolysis green hydrogen production.

The basic concepts have been described above, apparently, in detail, as will be described above, and do not constitute limitations of the disclosure. Although there is no clear explanation here, those skilled in the art may make various modifications, improvements, and corrections of the present disclosure. This type of modification, improvement, and corrections are recommended in the present disclosure, so the modifications, improvements, and the corrections remain in the spirit and scope of the exemplary embodiment of the present disclosure.

At the same time, the present disclosure uses specific words to describe the embodiments of the present disclosure. As “one embodiment,” “an embodiment,” and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of the present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the subject matter of the present disclosure requires more features than the features mentioned in the claims. Rather, the claimed subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the terms “about,” “approximate,” or “substantially.” Unless otherwise stated, “about,” “approximate,” or “substantially” may indicate ±20% variation of the value it describes. Accordingly, in some embodiments, the numerical parameters used in the disclosure and claims are approximate values, and the approximation may change according to the characteristics required by the individual embodiments. In some embodiments, the numerical parameter should consider the prescribed effective digits and adopt a general digit retention method. Although in some embodiments, the numerical fields and parameters used to confirm the breadth of its range are approximate values, in specific embodiments, such numerical values are set as accurately as possible within the feasible range.

With respect to each patent, patent application, patent application disclosure, and other material cited in the present disclosure, such as articles, books, manuals, publications, documents, etc., the entire contents thereof are hereby incorporated by reference into the present disclosure. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those described in the present disclosure, the descriptions, definitions, and/or use of terms in the present disclosure shall prevail.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A preparing method for a low Pt-loaded MXene-carbon nanotube aerogel film, comprising:
S1, adding LiF to a HCl solution to prepare a composite etching solution, wherein a concentration of the HCl solution is within a range of 5.0-7.0 M, and an addition amount of the LiF in the HCl solution is within a range of 0.06-0.1 g/mL;
slowly adding Ti₃AlC₂ powder to the composite etching solution, and mixing and stirring to obtain a colloidal solution, washing the colloidal solution with deionized water to separate a solid and drying the solid to obtain MXene nanosheets, and dispersing the MXene nanosheets in deionized water at a dispersion concentration of 60-100 mg/mL to obtain an MXene colloidal suspension;
S2, slowly adding a H₂PtCl₆ solution to the MXene colloidal suspension to obtain a suspension, denoted as Pt@MXene nanosheet suspension, wherein Pt is loaded on the MXene nanosheets to obtain Pt-loaded MXene nanosheets, a concentration of the H₂PtCl₆ solution is within a range of 10-30 mg/mL, and a mass ratio of H₂PtCl₆ in the H₂PtCl₆ solution to the MXene nanosheets in the MXene colloidal suspension is within a range of (0.5-3): 100;
S3, preparing a carbon nanotube (CNT) suspension, mixing the Pt@MXene nanosheet suspension with the carbon nanotube suspension to obtain a mixed suspension under ultrasonic treatment; wherein a concentration of the CNT suspension is within a range of 10-30 mg/mL, and a volume ratio of the Pt@MXene nanosheet suspension to the carbon nanotube suspension is 1:7; and
S4, cooling a metal plate in liquid nitrogen in advance, placing the mixed suspension on a surface of the metal plate for rapid freezing, and freeze-drying to obtain an aerogel film with a thickness of 0.4-1 mm, wherein the Pt-loaded MXene nanosheets and carbon nanotubes in the aerogel film are interlaced and overlapped to form vertical pores, which is the low Pt-loaded MXene-carbon nanotube aerogel film, and the low Pt-loaded MXene-carbon nanotube aerogel film is used as a self-supporting integrated industrial electrolytic water hydrogen production electrode.

2. The preparing method of claim 1, wherein in step S1, the concentration of the HCl solution is within a range of 5.0-7.0 M, and the addition amount of the LiF in the HCl solution is within a range of 0.06-0.1 g/mL.

3. The preparing method of claim 1, wherein in step S1, a mass ratio of the Ti₃AlC₂ powder to the LiF in the composite etching solution is within a range of (0.5-1):1.

4. The preparing method of claim 1, wherein in step S4, a temperature of the freeze-drying is within a range of (−35° C.)-(−75° C.), and a time of the freeze-drying is within a range of 5-18 h.

5. A low Pt-loaded MXene-carbon nanotube aerogel film, which is prepared by the preparing method of claim 1.
